(19) United States
(12) Patent Application Publication
(10) Pub. No.: US 2025/0279747 A1
(43) Pub. Date: Sep. 4, 2025

(54) Extendable Solar Assembly for Vehicle

(71) Applicant: Carefree/Scott Fetzer Company, Broomfield, CO (US)

(72) Inventors: James Tyler KINNEY, Arvada, CO (US); David Thomas McMILLAN, Broomfield, CO (US); Kevin Paul MAYER, Boulder, CO (US)

(73) Assignee: Carefree/Scott Fetzer Company, Broomfield, CO (US)

(21) Appl. No.: 19/070,182

(22) Filed: Mar. 4, 2025

Related U.S. Application Data
(60) Provisional application No. 63/561,010, filed on Mar. 4, 2024.

(51) Int. Cl. H02S 30/20; H02S 20/30

(52) U.S. Cl. CPC H02S 30/20; H02S 20/30

(57) ABSTRACT

An extendable solar assembly for removably attaching to a vehicle is disclosed herein. The extendable solar assembly may comprise a housing securely affixed to a vehicle during use and a set of solar panels configured to be stacked within the housing when the extendable solar assembly is in the retracted position. The extendable solar assembly further comprises lateral arms and/or tracks configured to support the set of solar panels and cause the set of solar panels to extend and retract as the extendable solar assembly extends from a retracted position to an extended position. The set of solar panels and each of the lateral arms and/or tracks are all retracted within the housing when the extendable solar assembly is in the retracted position. The extendable solar assembly comprises a self-contained, standalone unit configured to be removed and attached to another structure.

### RELATED APPLICATIONS

This application claims priority to U.S. Provisional Patent Application No. 63/561,010 filed Mar. 4, 2024, the content of which is hereby incorporated herein by reference in its entirety.

### FIELD OF THE DISCLOSURE

The present invention relates to an extendable solar assembly and method of making same and, more particularly, an extendable solar assembly that provides power to vehicle.

### BACKGROUND OF THE INVENTION

Persons traveling in vehicles across long distances often require power during stationary periods. However, utilizing that power can drain batteries and cause vehicles to fail. Further, green energy is beneficial for the environment, and solar power is a good source of green energy. Additionally, certain types of vehicles may have unique power requirements (e.g., for refrigeration of medical supplies, such as vaccines). It is also typical for certain vehicles to only travel at night and rest during the day, creating unique issues when it comes to maintaining their cargo. Solutions for generating power using green energy when a vehicle is stopped to power appliances, devices, or utilities exist, but these solutions have numerous drawbacks. Indeed, it is common for persons traveling in recreational vehicles to set up solar panels when stopped to generate electricity. However, such solar panels can be cumbersome to set up, take down, and store. Additionally, these solar panels are often set up on the ground, potentially taking up valuable space near the vehicle, presenting a safety hazard for those in the vicinity, while also exposing the solar panels themselves to risk of damage from moving bodies, vehicles, and other equipment. Accordingly, there is a need for improved solutions for generating power from renewable sources when a vehicle is stopped to power appliances, devices, or utilities that may be easily installed on a vehicle and selectively utilized regardless of space or time constraints.

### SUMMARY OF THE INVENTION

Aspects of this disclosure relate to an extendable solar assembly for a vehicle or other structure. In various embodiments, the extendable solar assembly comprises a housing securely affixed to a structure during use, a set of arms attached to the housing and configured to support a lead rail of the extendable solar assembly as the extendable solar assembly extends from a retracted position to an extended position, at least one track coupled to the housing and the lead rail and configured to extend and retract as the extendable solar assembly extends from the retracted position to the extended position, and a set of solar panels coupled to the at least one track that are configured to be stacked within the housing when the extendable solar assembly is in the retracted position. In various embodiments, the structure may comprise an exterior surface of a vehicle. In various embodiments, each of the set of arms, the at least one track, and the set of solar panels are all retracted within the housing when the extendable solar assembly is in the retracted position. In some embodiments, at least one solar panel of the set of solar panels remains exposed, is able to gather sunlight to generate electricity, and comprises a top surface of the extendable solar assembly when the set of solar panels are stacked within the housing (i.e., when the extendable solar assembly is in the retracted position). In some embodiments, the topmost solar panel when the solar panels are stacked within the housing may comprise a curved solar panel (e.g., to increase solar incidence). In some embodiments, each of the set of solar panels are stacked face up within the housing when the extendable solar assembly is in the retracted position. In other embodiments, each solar panel of the set of solar panels is stacked in an alternating manner relative to at least one adjacent solar panel of the set of solar panels within the housing when the extendable solar assembly is in the retracted position. In various embodiments, the extendable solar assembly comprises a self-contained, standalone unit configured to be removed and attached to another structure.

In various embodiments, the at least one track may comprise a first track and a second track, wherein the set of solar panels are coupled to both the first track and the second track. In some embodiments, the set of solar panels may be coupled to the at least one track via progressively taller risers. In some embodiments, the at least one track may comprise an angled track. In some embodiments, the at least one track may comprise a stackable track including a series of stackable links, each pivotably movable with respect to an adjacent stackable link.

In various embodiments, the extendable solar assembly may comprise one or more actuators connected to at least the lead rail and configured to cause the extendable solar assembly to extend from the retracted position to the extended position. In some such embodiments, the one or more actuators may be retracted within the housing when the extendable solar assembly is in the retracted position. In some embodiments, the set of arms themselves may comprise actuated arms configured to cause the extendable solar assembly to move between the retracted position and the extended position. In some embodiments, the extendable solar assembly may comprise a motor configured to manipulate a strap or a cable to cause extendable solar assembly to move between the retracted position and the extended position.

Another aspect of this disclosure relates to an extendable solar assembly comprising a housing securely affixed to a structure during use, a set of sliding arms configured to extend outwardly when the extendable solar assembly extends from a retracted position to an extended position and collapse when the extendable solar assembly retracts from the extended position to the retracted position, and a set of solar panels that are coupled to the set of sliding arms, wherein the solar panels are configured to be stacked within the housing when the extendable solar assembly is in the retracted position. In such an embodiment of an extendable solar assembly described herein, a lead rail may be absent or entirely decorative. Instead, in some embodiments, the set of solar panels may be extended and retracted using the set of slidable lateral arms. In various embodiments, the set of sliding arms include two sliding arms, each configured to support an outside edge of the set of solar panels. In various embodiments, the set of sliding arms are configured to retract within the housing when the extendable solar assembly is in the retracted position. In various embodiments, when the set of solar panels are stacked within the housing when the extendable solar assembly is in the retracted position, at least one solar panel of the set of solar panels may remain exposed, is able to gather sunlight to generate electricity, and comprises a top surface of the extendable solar assembly. In various embodiments, the extendable solar assembly comprises a self-contained, standalone unit configured to be removed and attached to another structure.

These and other objects, functions, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a top perspective view of an example extendable solar assembly in an extended position, according to one or more aspects described herein;

FIG. 2 depicts a bottom perspective view of an example extendable solar assembly in an extended position, according to one or more aspects described herein;

FIG. 3 depicts a front elevation view of an example extendable solar assembly, according to one or more aspects described herein;

FIG. 4 depicts a side view of an example embodiment of an extendable solar assembly in an extended position, according to one or more aspects described herein;

FIG. 5 depicts a side view of another example embodiment of an extendable solar assembly in an extended position, according to one or more aspects described herein;

FIG. 6 depicts a side view of a portion of an example stackable track of an extendable solar assembly including a stackable/link function, according to one or more aspects described herein;

FIG. 7 depicts a side view of an example embodiment of an extendable solar assembly having a stackable track in an extended position, according to one or more aspects described herein;

FIG. 8 depicts a cross-sectional view of an example extendable solar assembly having a stackable track in a retracted position, according to one or more aspects described herein;

FIG. 9 depicts top cross-sectional views of an example extendable solar assembly having an angled actuator in an extended and retracted position, according to one or more aspects described herein;

FIG. 10 depicts top cross-sectional views of an example extendable solar assembly having perpendicular actuators in an extended and retracted position, according to one or more aspects described herein;

FIG. 11 depicts top cross-sectional views of an example extendable solar assembly having actuated lateral arms in an extended and retracted position, according to one or more aspects described herein;

FIG. 12 depicts top cross-sectional views of an example extendable solar assembly having spring-loaded lateral arms in an extended and retracted position, according to one or more aspects described herein;

FIG. 13 depicts top cross-sectional views of an example extendable solar assembly having a scissor mechanism in an extended and retracted position, according to one or more aspects described herein;

FIG. 14 depicts side cross-sectional views of an example extendable solar assembly having a drawer slider mechanism in an extended and retracted position, according to one or more aspects described herein; and

FIG. 15 depict perspective views of an example extendable solar assembly installed on a vehicle, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example functions and elements of the invention, these terms are used herein as a matter of convenience, e.g., based on the example orientations shown in the figures. Nothing in this specification should be construed as requiring a specific three-dimensional orientation of structures in order to fall within the scope of this invention.

The invention described herein relates to an extendable solar assembly that can be installed on a structure (such as an exterior surface of a vehicle). In various embodiments, the extendable solar assembly comprises a housing securely affixed to the structure during use and a set of solar panels configured to be stacked within the housing when the extendable solar assembly is in the retracted position. In some embodiments, the extendable solar assembly may comprise a set of arms attached to the housing and a track, wherein the set of arms are configured to support a lead rail as the extendable solar assembly extends from a retracted position to an extended position, and the track is coupled to the housing and the lead rail and is configured to extend and retract as the lead rail extends, causing the set of solar panels to extend and retrack. In other embodiments, the extendable solar assembly may instead further include a set of sliding arms configured to extend outwardly when moving to an extended position and collapse when moving to the retracted position, causing the set of solar panels to do the same. In either respect, the extendable solar assembly comprises a self-contained, standalone unit configured to be removed and attached to another structure.

In various embodiments, the extendable solar assembly described herein may be couplable to a residence, vehicle, or other structure. For example, an extendable solar assembly, as disclosed herein, may be coupled to, securely attached/affixed, and/or removably secured to a residence, vehicle, or other structure. For ease of understanding and illustration, extendable solar assembly 200 is described and depicted herein as coupled (or otherwise attachable) to a vehicle 10 as a non-limiting example. For example, extendable solar assembly 200 may be coupled to an exterior surface of a car, truck, bus, camping car, trailer, recreational vehicle, or any other type of vehicle or wheeled object. However, it is to be understood that extendable solar assembly 200 may similarly be coupled (or otherwise attachable) to a residence or other moving or stationary structure aside from vehicle 10.

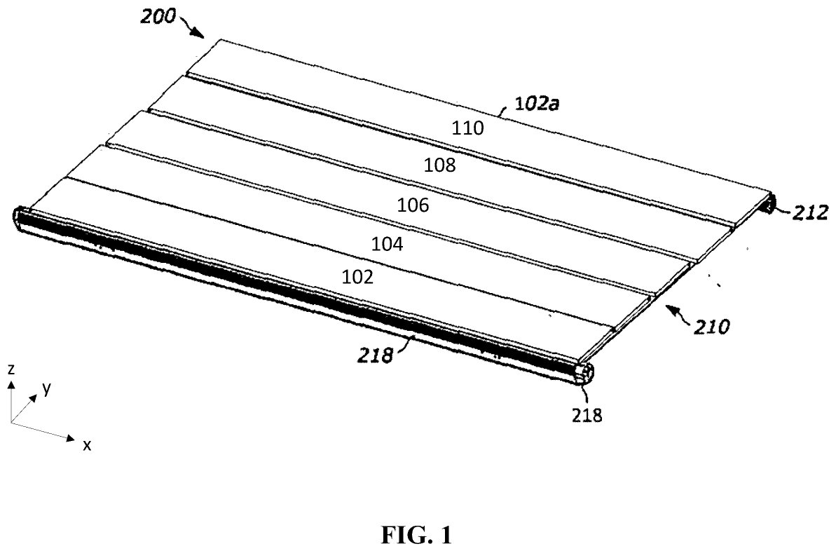

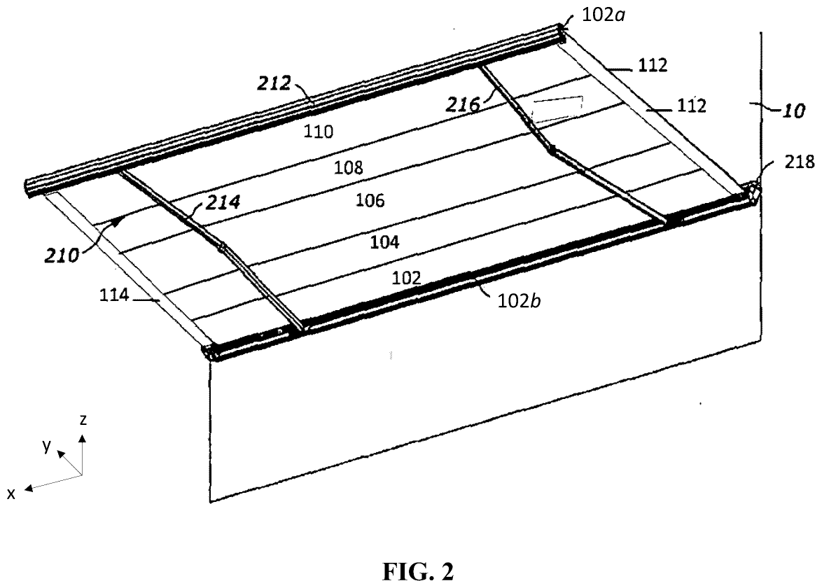

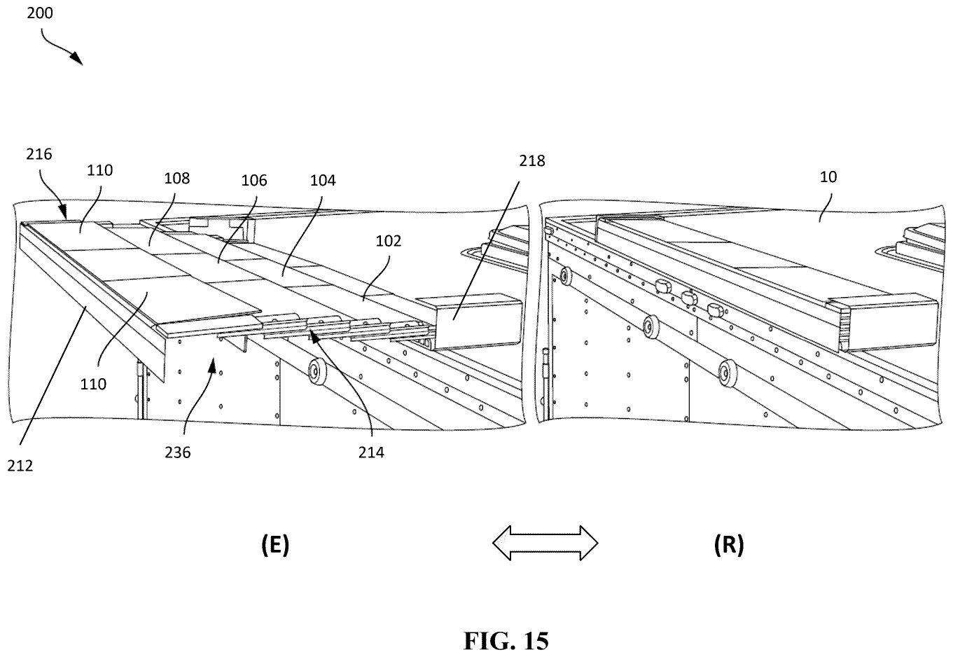

FIG. 1 and FIG. 2 depict various views of extendable solar assembly 200 in an extended position, according to one or more aspects described herein. For example, FIG. 1 depicts a top perspective view of extendable solar assembly 200 in an extended position, and FIG. 2 depicts a bottom perspective view of extendable solar assembly 200 in an extended position. In various embodiments, extendable solar assembly 200 may include a support structure 210 configured to support a set of solar panels 102-110. In various embodiments, support structure 210 may comprise a lead rail 212, one or more lateral arms (e.g., first and second lateral arms 214, 216 or sliding arms 214, 216), a housing 218, and/or one or more other components. As depicted, for example, in FIG. 2 and FIG. 15, the one or more lateral arms of extendable solar assembly may comprise a first lateral arm 214 and a second lateral arm 216 (or a set of sliding arms 214, 216) that extend away from housing 218 as extendable solar assembly 200 extends from a retracted position to an extended position. However, in some embodiments, extendable solar assembly 200 may include only a single lateral arm or more than two lateral arms. In various embodiments, housing 218 may comprise a cassette or a box in which some or all of the components of extendable solar assembly 200 are housed when extendable solar assembly 200 is in a retracted position. In various embodiments, housing 218 may be coupled, securely affixed, removably attached, and/or otherwise connected to a structure (e.g., vehicle 10). Together, the one or more components of extendable solar assembly 200 may form an awning canopy with the set of solar panels 102-110 defining a top surface of the awning canopy.

In various embodiments, the one or more lateral arms of extendable solar assembly 200 may comprise a set of arms configured to support the set of solar panels 102-110 as extendable solar assembly 200 extends from a retracted position to an extended position. In various embodiments, the one or more lateral arms may be connected, at least at one end, to housing 218, and are configured to extend as extendable solar assembly 200 moves between a retracted and extended position. In some embodiments (for example, as depicted in FIG. 2), the one or more lateral arms of extendable solar assembly 200 may comprise a first lateral arm 214 and a second lateral arm 216 configured to support the set of solar panels 102-110 from below as extendable solar assembly 200 extends from a retracted position to an extended position. In some embodiments, first and second lateral arms 214, 216 may be configured to support lead rail 212 when extendable solar assembly 200 is not in a retract position (e.g., when extending and when in an extended position). In other embodiments (for example, as depicted in FIG. 15 and described further herein), the one or more lateral arms of extendable solar assembly 200 may comprise a set of sliding arms 214, 216 that each support an outside edge of the set of solar panels 102-110.

In some embodiments, the one or more lateral arms (e.g., first and second lateral arms 214, 216) may comprise a proximal arm (positioned closer to housing 218 when in an extended position) and a distal arm (positioned further from housing 218 when in an extended position) pivotally joined together at an arm elbow. For example, the one or more lateral arms may comprise arms each having a proximal first arm and a distal second arm pivotally joined together at an arm elbow as described in U.S. Patent Application No. 10,316,522, entitled “Residential Awning Canopy Assembly,” filed Jul. 25, 2018, the content of which is hereby incorporated by reference herein in its entirety. In some embodiments, the proximal and distal arms may rotate with respect to each other at the arm elbows such that each proximal arm may be closer to being axially aligned with its respective distal arm when extendable solar assembly 200 is in an extended position. In such embodiments, each set of proximal and distal arms may be substantially parallel and adjacent to each other when extendable solar assembly 200 is in a retracted (or stowed) position.

In various embodiments, the one or more lateral arms of support structure 210 may provide vertically sound structural stability to one or more solar panels mounted on the extendable solar assembly 200. In some embodiments (for example, as depicted in FIG. 2), first and second lateral arms 214, 216 of support structure 210 may be spaced apart from one another to provide appropriate structural support for one or more solar panels across the support structure 210. For example, first and second lateral arms 214, 216 may be spaced apart from one another to ensure good distribution of the load (i.e., one or more solar panels 102-110) of extendable solar assembly 200 while minimizing shear and tensile stress caused by weight of one or more solar panels 102-110 within support structure 210.

In various embodiments, extendable solar assembly 200 may include a lead rail 212. For example, as depicted in FIG. 2, extendable solar assembly 200 may include a lead rail 212 that is supported by the one or more lateral arms of support structure 210 (e.g., first and second lateral arms 214, 216) when extendable solar assembly 200 is in an extended position. In some embodiments, lead rail 212 may be coupled to a track 112 at a first end 102a of extendable solar assembly 200 when extendable solar assembly 200 is in an extended position. In some embodiments, lead rail 212 may be coupled to a second track 114 in the same manner. For example, when second track 114 exists, second track 114 may include a mirror image of track 112. In some embodiments, track 112 may also be attached to housing 218 at a second end 102b of extendable solar assembly 200 when extendable solar assembly 200 is in an extended position. In various embodiments, the track 112 may be extended responsive to the lead rail 212 being extended away from the housing 218 and retracted responsive to the lead rail being retracted toward housing 218. In some embodiments, lead rail 212 may be propelled and retracted to move extendable solar assembly 200 between an extended and retracted position. For example, in some embodiments, lead rail 212 may be propelled and retracted to move extendable solar assembly 200 between an extended and retracted position via the one or more lateral arms (e.g., first and second lateral arms 214, 216) and/or via the one or more tracks (e.g., track 112 and/or track 114). In other embodiments, lead rail 212 may be purely decorative. For example, in FIG. 15 (described further herein), lead rail 212 (not shown) may simply comprise a front edge of extendable solar assembly 200. In some such embodiments, however, lead rail 212 may also protect a front edge of extendable solar assembly 200 and/or provide rigidity or otherwise support a front, long edge of extendable solar assembly 200.

In various embodiments, extendable solar assembly 200 may include a set of solar panels 102-110. As depicted in FIG. 2, for example, extendable solar assembly 200 may include a first, second, third, fourth, and fifth solar panel 102, 104, 106, 108, 110. While depicted and described herein as including a set of five solar panels (solar panels 102, 104, 106, 108, 110), it is to be understood that any number of solar panels may be used. Indeed, it would be appreciated by one having ordinary skill in the art that more or less than five solar panels are contemplated. For example, in some embodiments, extendable solar assembly 200 may include two solar panels, while, in other embodiments, extendable solar assembly 200 may include six or more solar panels.

In various embodiments, the set of solar panels 102-110 may be coupled to one or more tracks (e.g., track 112) of extendable solar assembly 200. In some embodiments, the one or more tracks of extendable solar assembly 200 (e.g., track 112 and/or second track 114) may be made of light weight material such as aluminum, plastic, ceramics, or the like. In some embodiments, extendable solar assembly 200 may include a track 112 that extends along a first lateral edge of extendable solar assembly 200 and/or solar panels 102-110. In some such embodiments, extendable solar assembly 200 may also include a second track 114 that extends along a second lateral edge of the extendable solar assembly 200 and/or solar panels 102-110. In such embodiments, the second lateral edge may be opposite the first lateral edge, and each of the first lateral edge and the second lateral edge may extend between a first end 102a and a second end 102b of extendable solar assembly 200 (e.g., between lead rail 212 and housing 218 when extendable solar assembly 200 is in an extended position).

In various embodiments, when extendable solar assembly 200 is in a retracted (or stowed) position, the set of solar panels 102-110 may be stacked (one on top of the other) within housing 218. In some embodiments, when retracting the set of solar panels (i.e., when moving from an extended position to a retracted position), the set of solar panels 102-110 may be retracted by first stacking (or vertically aligning) the solar panels furthest from housing 218. In other embodiments, when retracting the set of solar panels (i.e., when moving from an extended position to a retracted position), the set of solar panels 102-110 may be retracted by first stacking (or vertically aligning) the solar panels closest to housing 218. For example, and referring to FIG. 1 and FIG. 2, when retracting the set of solar panels 102-110 by first stacking (or vertically aligning) the solar panels furthest from housing 218, fifth solar panel 110 (i.e., or the solar panel from housing 218) may first be retracted to be vertically aligned with fourth solar panel 108. Responsive to fourth solar panel 108 being vertically aligned with fifth solar panel 110, the stacked fourth and fifth solar panels 108, 110 may be retracted to be vertically aligned with third solar panel 106 as extendable solar assembly 200 continues to retract. Responsive to the third solar panel 106 being vertically aligned with the fourth and fifth solar panels 108, 110, the stacked third, fourth and fifth solar panels 106, 108, 110 may be retracted to be vertically aligned with second solar panel 104 as extendable solar assembly 200 continues to retract. Responsive to the second solar panel 104 being vertically aligned with the third, fourth and fifth solar panels 106, 108, 110, the stacked second, third, fourth and fifth solar panels 104, 106, 108, 110 may be retracted to be vertically aligned with the first solar panel 102 as extendable solar assembly continues 200 to retract (until extendable solar assembly 200 is fully retracted).

As another example, and referring to FIG. 1 and FIG. 2, when retracting the set of solar panels 102-110 by first stacking (or vertically aligning) the solar panels closest to housing 218, second solar panel 104 (i.e., or the solar panel from housing 218) may first be retracted to be vertically aligned with first solar panel 102. Responsive to first solar panel 102 being vertically aligned with second solar panel 104, third solar panel 106 may be retracted to be vertically aligned with the stacked first and second solar panels 102, 104 as extendable solar assembly 200 continues to retract. Responsive to the third solar panel 106 being vertically aligned with the first and second solar panels 102, 104, the fourth solar panel 108 may be retracted to be vertically aligned with the stacked first, second, and third solar panels 102, 104, 106 as extendable solar assembly 200 continues to retract. Responsive to the fourth solar panel 108 being vertically aligned with the first, second, and third solar panels 102, 104, 106, the fifth solar panel 110 may be retracted to be vertically aligned with the first, second, third, and fourth solar panels 102, 104, 106, 108 as extendable solar assembly continues 200 to retract (until extendable solar assembly 200 is fully retracted).

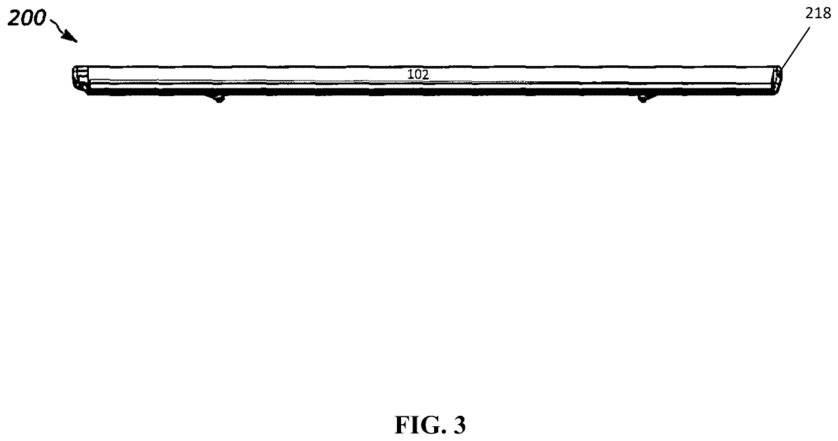

In some embodiments, the set of solar panels 102-110 may be retracted one at a time (or concurrently) as described in each of the foregoing examples. In other embodiments, the set of solar panels 102-110 may all be retracted simultaneously. For example, in some embodiments, the set of solar panels 102-110 may be retracted such that each of the set of solar panels 102-110 becomes vertically aligned with another solar panel at the same time (i.e., when all of the solar panels are aligned in the retracted position). In some embodiments, the solar panel furthest from housing 218 when extendable solar assembly is in an extended position (e.g., solar panel 110) may comprise a top (or uppermost) solar panel when extendable solar assembly 200 is in a retracted position. In other embodiments, the solar panel furthest from housing 218 when extendable solar assembly is in an extended position (e.g., solar panel 110) may comprise a bottom (or lowermost) solar panel when extendable solar assembly 200 is in a retracted position. In such embodiments, the solar panel closest to housing 218 when extendable solar assembly is in an extended position (e.g., solar panel 102) would comprise the top (or uppermost) solar panel when extendable solar assembly 200 is in a retracted position. For example, as depicted in FIG. 3, a solar panel closest to housing 218 when extendable solar assembly is in an extended position (e.g., solar panel 102) may comprise a top solar panel when extendable solar assembly 200 is in a retracted position. In this way, a top solar panel (e.g., solar panel 102) (or a top set of solar panels) may remain exposed and is able to gather sunlight to generate electricity (or power) when extendable solar assembly 200 is in a retracted position. For example, as described further herein, extendable solar assembly 200 may operate in a low-power mode, or a lower power state, compared to the operation of extendable solar assembly 200 when the extendable solar assembly 200 in an extended position. Such a low-power mode may still have use for long term storage and trickle charging batteries, for example. In some embodiments, a top solar panel when extendable solar assembly 200 is in a retracted position may be curved to increase solar incidence, both when extendable solar assembly 200 is in a retracted position and when extendable solar assembly 200 is in an extended position. In some embodiments, the top solar panel and/or one or more other solar panels of the set of solar panels included in extendable solar assembly 200 may be curved to increase solar incidence. For example, in some embodiments, a subset of the set of solar panels included in extendable solar assembly 200 that are exposed when extendable solar assembly 200 is in a retracted position may each be curved to increase solar incidence.

In various embodiments, the set of solar panels 102-110 may be configured to generate electricity from solar energy (or sunlight). In some embodiments, the set of solar panels 102-110 may be connected to a solar cable that transmits energy to a battery, an electrical box of a vehicle 10 (or other structure to which extendable solar assembly 200 is attached), an electrical grid, or a battery connected to an electrical box of a vehicle 10 (or other structure to which extendable solar assembly 200 is attached).

In various embodiments, some or all of the components of extendable solar assembly 200 may be included or encompassed within housing 218 when extendable solar assembly 200 is in a retracted position. For example, in some embodiments, the set of solar panels 102-110, the one or more lateral arms, and/or one or more other components of extendable solar assembly 200 may be included or encompassed within a cavity formed by housing 218 when extendable solar assembly is in a retracted position. In some embodiments, all of the components of extendable solar assembly 200 are included or encompassed within a cavity formed by housing 218 when extendable solar assembly is in a retracted position. For example, in some embodiments, each of the set of solar panels 102-110, one or more lateral arms, one or more tracks (described herein), and any other components of a given embodiment of extendable solar assembly 200 may included or encompassed within a cavity formed by housing 218 when extendable solar assembly is in a retracted position. In various embodiments, at least the one or more lateral arms may be stowed (or otherwise included) within housing 218 (in addition to at least the set of solar panels 102-110) when extendable solar assembly 200 is in a retracted position. For example, first and second lateral arms 214, 216 may fold together to be stowed within the housing 218. In some embodiments, housing 218 may be attachable (removably attached) to a wall or other mounting surface. For example, housing 218 may be attached to a vehicle 10 (e.g., a mobile home, truck, bus, or other vehicle) or other structure. In some embodiments, a front cap may encapsulate/cover an opening defined in housing 218, and thus retain first and second lateral arms 214, 216, one or more solar panels 102-110, and/or one or more other components of extendable solar assembly 200 when extendable solar assembly is in a retracted position.

In some embodiments, housing 218 may be completely enclosed when extendable solar assembly 200 is in a retracted position. In this way, extendable solar assembly 200 may comprise a self-contained, standalone unit that may be removed and attached to another vehicle. Additional, extendable solar assembly 200, when completely enclosed, may provide added protection to the various components, for example, when vehicle 10 is moving. In other embodiments, one or more sides of housing 218 may be left open. For example, in some embodiments, a topmost solar panel (e.g., either solar panel 102 or solar panel 110) or a subset of the solar panels included in extendable solar assembly 200 may remain exposed by residing on or forming a top surface of housing 218 when extendable solar assembly 200 is in a retracted position. In some embodiments, when in a retracted position, extendable solar assembly 200 may operate in a low-power mode (or lower power state), in which just a single exposed solar panel (or a subset of the set of one or more solar panels 102-110) may be used to generate power (or electricity) from solar energy (or sunlight). For example, low-power mode may be used when a vehicle is moving (i.e., when the extendable solar assembly 200 may not be fully extended). When additional power is needed (or when vehicle 10 is parked), extendable solar assembly 200 may be extended to use each of the set of solar panels provided.

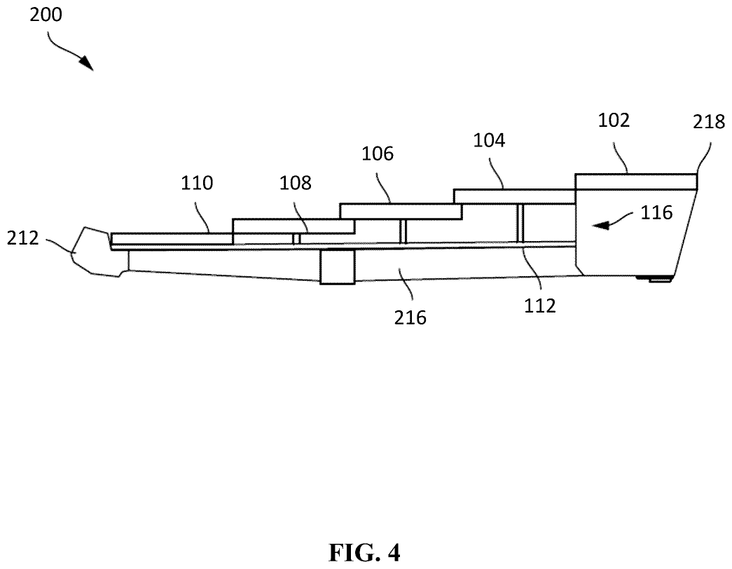

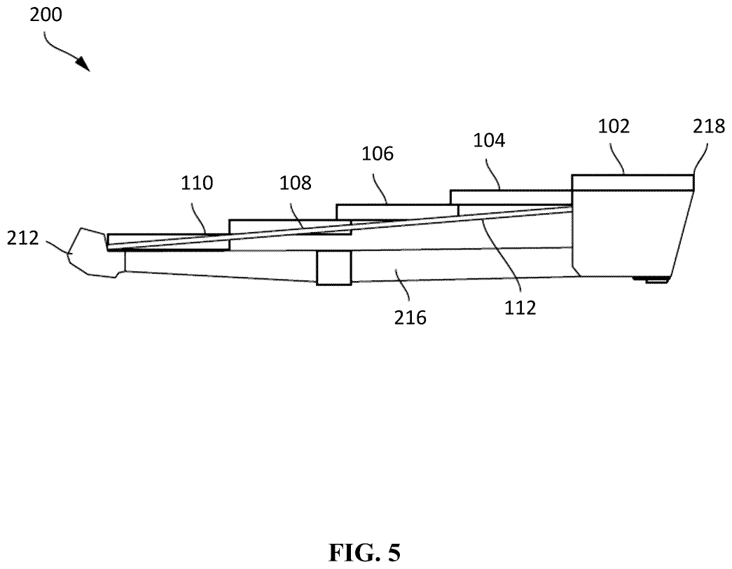

In various embodiments, the set of solar panels 102-110 may be coupled to a track 112 and/or a second track 114 along first and second (lateral) arms 214, 216 perpendicular to a longitudinal axis (or x-axis) of the housing 218 at an appropriate manner. In some embodiments, the set of solar panels may be coupled to one or more tracks via one or more progressively taller risers 116. For example, as depicted in FIG. 4, the set of solar panels 102-110 may be coupled to the track 112 (and/or second track 114 (not shown)) via one or more progressively taller risers 116. In such embodiments, solar panel 110 may be coupled to the lowest, or with no riser, so that solar panel 110 may be located underneath the adjacent solar panel, when retracted. In some embodiments, the set of solar panels may be coupled to one or more angled tracks. For example, as depicted in FIG. 5, the set of solar panels 102-110 may be coupled to an angled track 112 (and/or an angled second track 114 (not shown)). In such embodiments, angled track 112 may be a linear track with an appropriate angle θ, in order to be at a relative height that is greater than a relative height that the angled track is coupled to the lead rail. In various embodiments, extendable solar assembly 200 may be extended and retracted between the open (or extended) position (when extendable solar assembly 200 is in use) and the closed (or retracted) position (when extendable solar assembly 200 is not in use) manually.

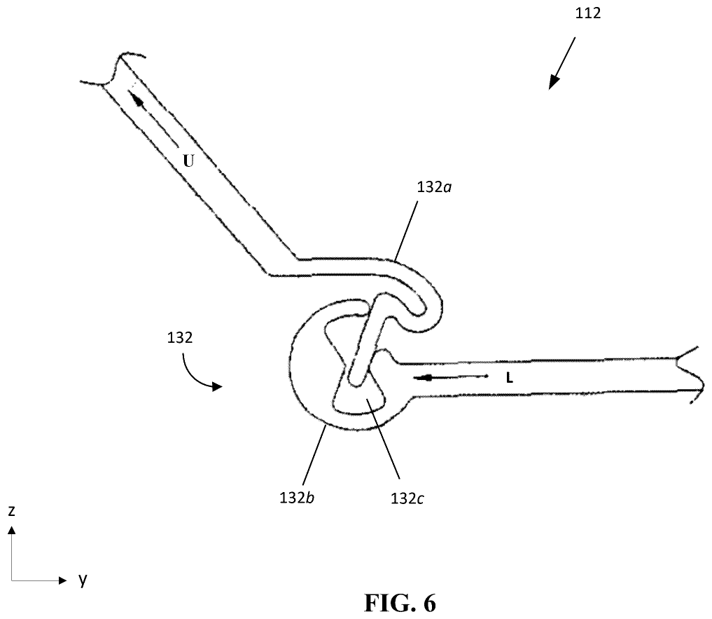

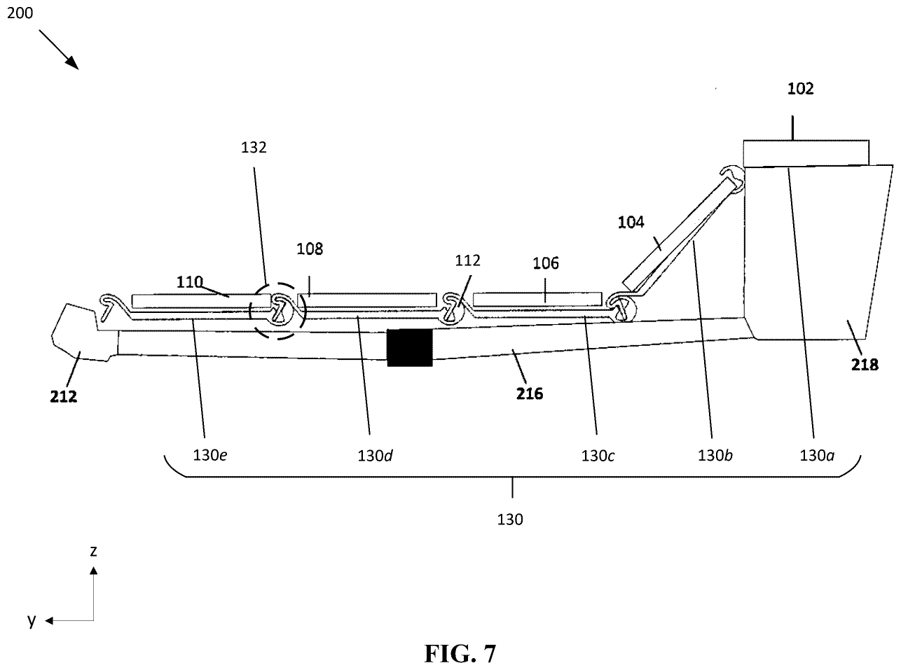

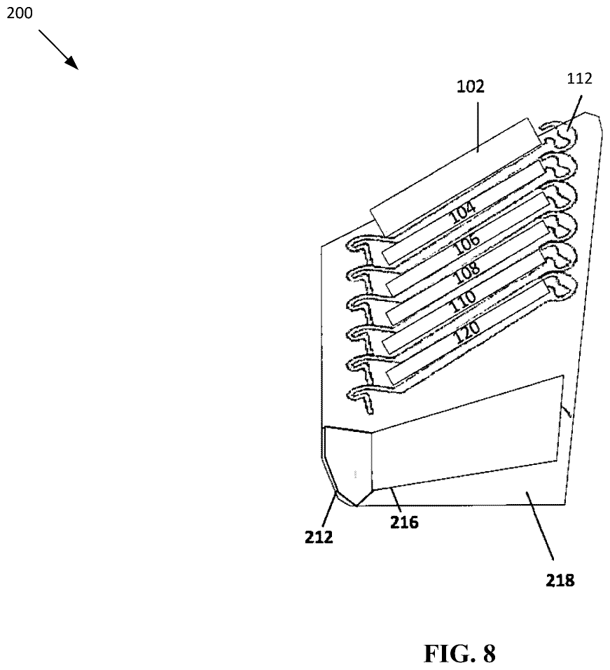

In some embodiments, the set of solar panels 102-110 may be coupled to one or more stackable tracks. For example, as depicted in FIGS. 6-8, a set of solar panels 102-110 may be coupled to a stackable track 112 (and/or a stackable second track 114 (not shown)). In various embodiments, for example, as depicted in FIG. 7, stackable track 112 may include a series of stackable links 130, each supporting one or more solar panels of the set of solar panels 102-110. In some embodiments, at least one solar panel (e.g., solar panel 102) may remain positioned atop housing 218. When retracted, and as depicted in FIG. 8, the stackable track 112 (and the set of solar panels 102-110, 120) may be folded (or stacked) and retracted within housing 218. In such embodiments, extendable solar assembly 200 may include an housing 218 removably attached to a mounting surface of a vehicle 10 or other structure (not shown), a track 112 removably attached to an opening of the housing 218 and configured to extend and retract between an extended position and a retracted position, a set of arms (e.g., first lateral arm 214 (not shown) and second lateral arm 216) configured to be slidably movable with respect to the housing 218 between the extended position and the retracted position to provide structural stability, and a set of solar panels 102-110 that are coupled to (or otherwise securely attached to) track 112. In some such embodiments, the set of solar panels 102-110 are extendable using a stackable/link function 132.

FIG. 6 depicts a cross-sectional view of a stackable track 112 of extendable solar assembly including a stackable/link function 132, according to one or more aspects described herein. In various embodiments, stackable track 112 may include stackable/link function 132. In various embodiments, stackable/link function 132 may comprise a first portion 132a (i.e., an inserting portion) and a second portion 132b (i.e., a receiving portion) that may operate using a ratchet mechanism engaging first portion 132a with second portion 132b. In such embodiments, first portion 132a of stackable/link function 132 may be mated to and received within an opening 132c of second portion 132b (or receiving portion). Such a ratchet mechanism may allow first portion 132a (or inserting portion) to be operatively coupled with second portion 132b of stackable/link function 132, wherein the ratchet mechanism positions the first portion relative to the second portion in a removably attaching (securing or fastening) manner. In various embodiments, the first portion 132a and second portion 132b may be removably attachable relative to one another, such that extendable solar assembly 200 may move between a retracted position and an extended position.

As depicted in FIG. 6 (and FIG. 7), as the extendable solar assembly 200 is retracted, each of the stackable links 130, in series, may push upward (as depicted as “U”) until the stackable link 130 uncouples from the proceeding stackable link 130, and stacks over the proceeding stackable link 130. As the extendable solar assembly 200 is extended, each of the stackable links 130, in series, may slide (e.g., pushes to left as depicted as “L”) toward a succeeding stackable link 130, until the stackable link 130 couples to the succeeding stackable link 130, and becomes substantially linear with the succeeding stackable link 130. In some embodiments, the solar panels 102-110 may be attached, and positioned substantially parallel, to an elongated surface of stackable link 130. Accordingly, solar panels 102-110 may extend and retract as stackable track 112 is extended and retracted, as described above.

FIG. 7 depicts a cross-sectional view of extendable solar assembly 200 having a stackable track 112 in an extended position, according to one or more aspects described herein. In various embodiments, extendable solar assembly 200 may include a set of solar panels 102, 104, 106, 108, 110 coupled to stackable links 130a, 130b, 130c, 130d, 130e. In some embodiments, the stackable links 130a, 130b, 130c, 130d, 130e may, using stackable/link function 132, extend away from housing 218 to lead rail 212 along first lateral arm 214 (not shown) and/or second lateral arm 216 perpendicular to a longitudinal axis (or x-axis) of housing 218. In various embodiments, stackable links 130a, 130b, 130c, 130d, 130e may be pivotably movable with respect to one another (and housing 218) between an open (or extended) position (i.e., when the extendable solar assembly is in use, as depicted in FIG. 7) and a closed (or retracted) position (i.e., when the extendable solar assembly is not in use, as depicted in FIG. 8), as described herein.

FIG. 8 depicts a cross-sectional view of extendable solar assembly 200 having a stackable track 112 in a retracted position, according to one or more aspects described herein. In various embodiments, when extendable solar assembly 200 is not in use, stackable track 112 may allow extendable solar assembly 200 to be stackable, collapsible, or reduced in length, so that the extendable solar assembly 200 may be stored back within the housing 218 (for example, as depicted in FIG. 8).

In various embodiments, extendable solar assembly 200 may include any suitable number of solar panels or stackable links 130. For example, as depicted in FIG. 7, extendable solar assembly 200 may include five stackable links 130. In some embodiments, the stackable links 130 may of equal length. In other embodiments, the stackable links 130 may be of different lengths. A stackable link 130 may be operatively coupled with another, wherein stackable/link function 132 of stackable link 130 pivotably positions the first portion of a first stackable link 130 relative to a second portion of a second stackable link 130. In some embodiments, the number of stackable links 130 used may be determined based on a coverage area when the extendable solar assembly is in use and/or a number of solar panels included in extendable solar assembly 200.

In various embodiments, stackable link 130 may be of any appropriate shape, size, type, or configuration, such that extendable solar assembly 200 may extend at an appropriate length when extendable solar assembly 200 is in a fully extended position. By way of a non-limiting example, the stackable link 130 may extend away from housing 218 to lead rail 212 along one or more lateral arms perpendicular to a longitudinal axis (or x-axis) of the housing 218 at an appropriate width.

In various embodiments, and by way of a non-limiting example, extendable solar assembly 200 may be any suitable length along a vehicle 10 or other structure. For example, extendable solar assembly 200 may be 5-20 feet in length (measured by the length of a mounting surface running along a vehicle 10 or other structure). By way of non-limiting example, extendable solar assembly 200 may be 10, 15, or 20 feet long. In various embodiments, when in an extended position, extendable solar assembly 200 may project from a vehicle 10 or other structure 3-6 feet. By way of non-limiting example, extendable solar assembly 200 may project 4 feet from a vehicle 10 or other structure to which extendable solar assembly 200 is attached (i.e., from first end 102a to second end 102b). It would be appreciated by one having ordinary skill in the art that extendable solar assembly may measure less than 5 feet in length and more than 20 feet in length. It would also be appreciated by one having ordinary skill in the art that extendable solar assembly 200 may project less than 3 feet and more than 6 feet from a vehicle when in an extended position.

Advantageously, the extendable solar assembly 200 provides power to the vehicle 10 or other structure to which extendable solar assembly 200 is coupled. For example, extendable solar assembly 200 may provide power to recreational vehicles when stationary, allowing users full enjoyment of electrical devices without worrying about reduced battery power.

In some embodiments, extendable solar assembly 200 may be secured in the closed/retracted position (or in the open position) via a biasing component. In various embodiments, the biasing component may comprise a spring. For example, the biasing component may comprise a torsion spring or any other suitable type of spring. In various embodiments, the extendable solar assembly 200 may include a locking portion configured to receive any appropriate biasing or locking components. In some embodiments, the biasing component may be adjusted to maintain a predetermined maximum and/or minimum length of the extendable solar assembly 200.

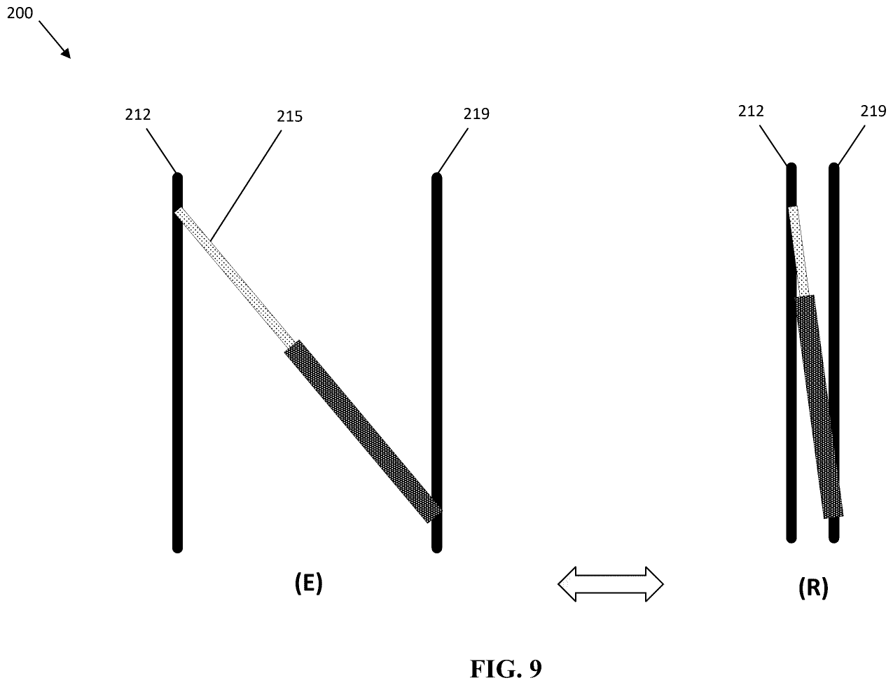

FIGS. 9-14 depict various views of alternative configurations (or mechanisms) for extending and retracting extendable solar assembly 200 between an extended (E) and retracted (R) position. For the purposes of illustration, the alternative configurations of FIGS. 9-14 are each depicted without a set of solar panels 102-110. However, it would be understood by a person of ordinary skill in the art that each of the alternative configurations of FIGS. 9-14 would include a set of solar panels 102-110, a housing 218, and/or one or more other components of extendable solar assembly 200, as described herein.

FIG. 9 depicts top cross-sectional views of extendable solar assembly 200 having an angled actuator 215 in an extended and retracted position, according to one or more aspects described herein. In various embodiments, extendable solar assembly 200 may include an actuator 215. For example, actuator 215 may comprise a gas spring actuator, an electronic actuator, and/or any other type of suitable actuator now known or future developed. In some embodiments, extendable solar assembly 200 may include an actuator 215 instead of or in addition to one or more lateral arms (e.g., first and second lateral arms 214, 216) and/or one or more tracks (e.g., track 112 and second track 114). In some embodiments, as depicted in FIG. 9, extendable solar assembly 200 may include an actuator 215 that is angled and connected directly to lead rail 212 and a fixed base 219. For example, the fixed base 219 may comprise, be included within, or located adjacent to housing 218. In some embodiments, angled actuator 215 may be slidably movable (i.e., angularly) with respect to fixed base 219, such that a lead rail 212 may move between an extended position (E) and a retracted position (R) as actuator 215 extends and an angle between angled actuator 215 and fixed base 219 increases. When extendable solar assembly 200 is in a retracted position, angled actuator 215 may be included or encompassed within a cavity formed by housing 218.

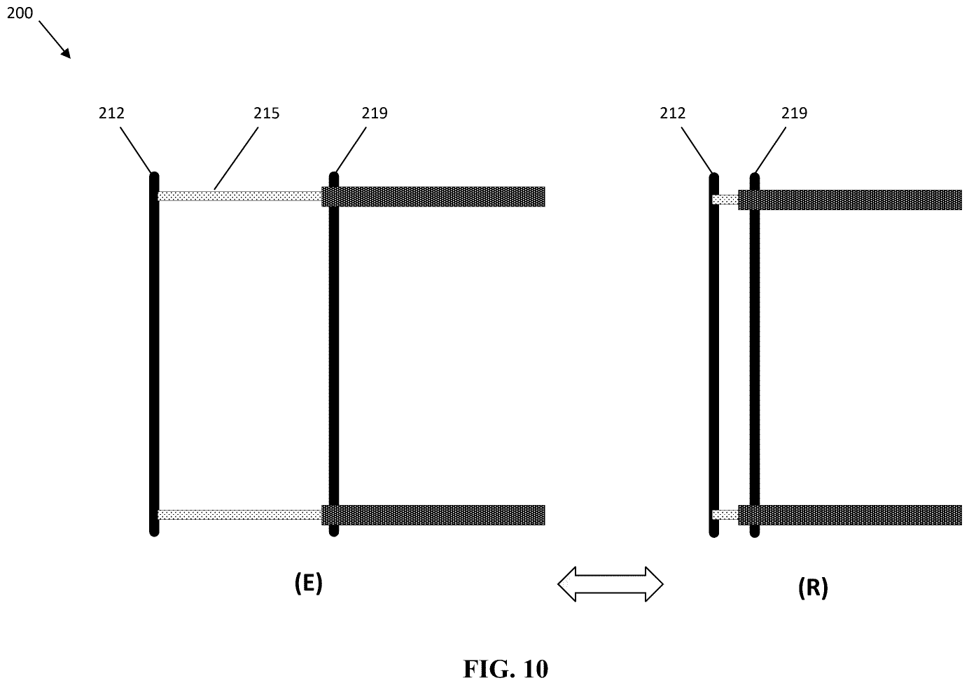

FIG. 10 depicts top cross-sectional views of extendable solar assembly 200 having perpendicular actuators 215 in an extended and retracted position, according to one or more aspects described herein. In some embodiments, extendable solar assembly 200 may include one or more actuator 215 that are perpendicular and directly connected to a lead rail 212 and fixed base 219. In such embodiments, extension of perpendicular actuator(s) 215 may cause lead rail 212 (and, accordingly, a set of solar panels 102-110) to move between a retracted and extended position. Similarly, retraction of perpendicular actuator(s) 215 may cause lead rail 212 (and, accordingly, a set of solar panels 102-110) to move between an extended and retracted position. In some embodiments, when extendable solar assembly 200 is in a retracted position, perpendicular actuator(s) 215 may be included or encompassed within a cavity formed by housing 218. In other embodiments, when extendable solar assembly 200 is in a retracted position, perpendicular actuator(s) 215 may positioned outside a cavity formed by housing 218. For example, in some embodiments, perpendicular actuator(s) 215 may be integrated in a roof rack or any other roof components.

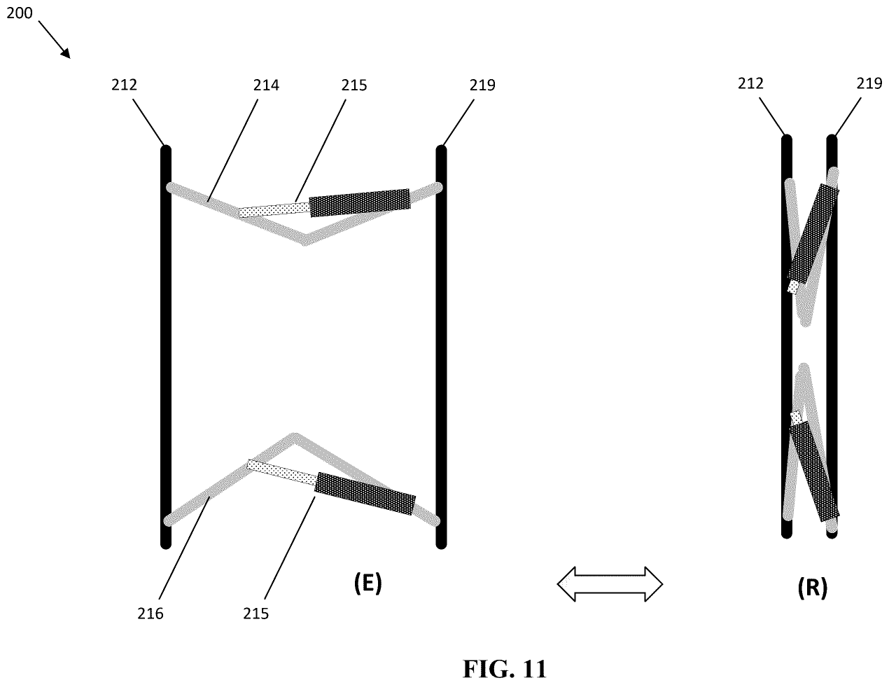

FIG. 11 depicts top cross-sectional views of extendable solar assembly 200 having actuated lateral arms 214, 216 in an extended and retracted position, according to one or more aspects described herein. In some embodiments, as depicted in FIG. 11, lateral arms 214, 216 of extendable solar assembly 200 may each include an actuator 215. For example, slidably movable actuators 215 may be configured to cause lateral arms 214, 216 to extend and propel lead rail 212 away from housing 218. Actuators 215 may similarly be used to cause lead rail to retract toward housing 218, thus enabling movement of lateral arms 214, 216 to control the movement of lead rail 212 and, in turn, the set of solar panels 102-110.

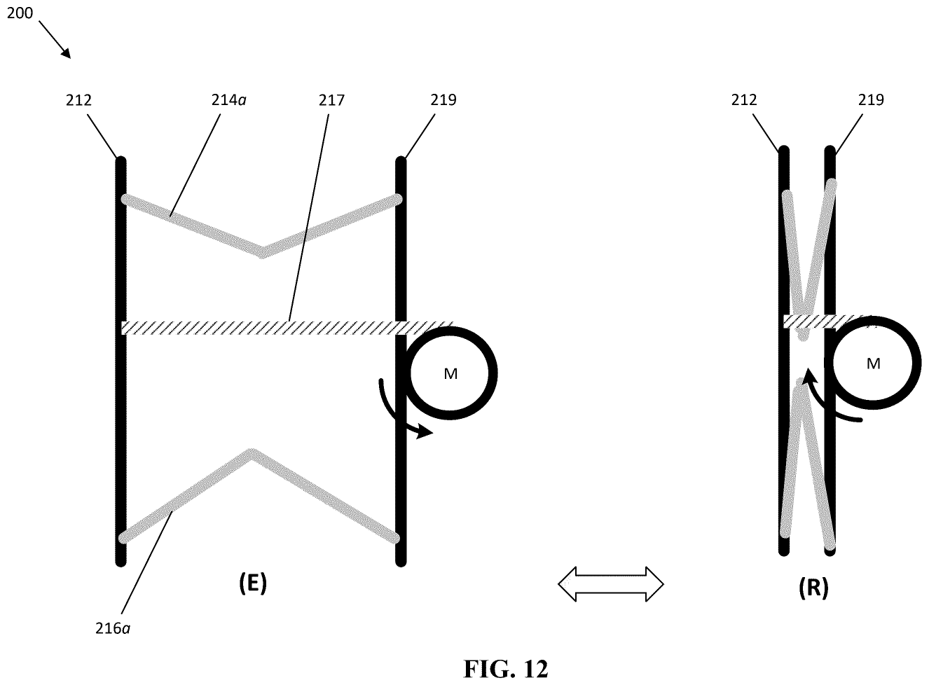

FIG. 12 depicts top cross-sectional views of extendable solar assembly 200 having spring-loaded lateral arms 214, 216 in an extended and retracted position, according to one or more aspects described herein. In some embodiments, as depicted in FIG. 12, extendable solar assembly 200 may include a strap 217 connected to a motor M. For example, strap 217 may be connected to lead rail 212, and motor M may be configured to pull strap 217 towards fixed base 219 to pull lead rail 212 towards housing 218. Accordingly, motor M may be configured to pull strap 217 to pull extendable solar assembly 200 into a retracted position. In such embodiments, lateral arms 214, 216 may be spring-loaded and configured to cause lead rail 212 to extend away from housing 218 when tension in strap 217 is released, thereby causing extendable solar assembly 200 to move into an extended position. In such an embodiment, lateral arms 214, 216 may comprise conventional box awning arms. In such an embodiment, strap 217 may replace a canopy as in a traditional awning.

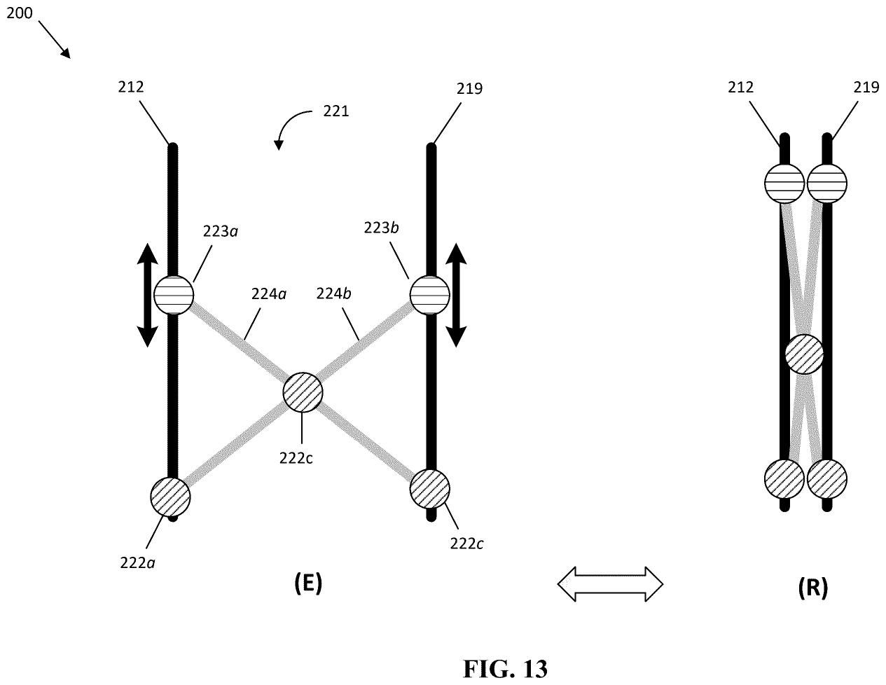

FIG. 13 depicts top cross-sectional views of extendable solar assembly 200 having a scissor mechanism in an extended and retracted position, according to one or more aspects described herein. In some embodiments, as depicted in FIG. 13, extendable solar assembly 200 may include a scissor mechanism 221. In some embodiments, extendable solar assembly 200 may include a scissor mechanism 221 instead of or in addition to one or more lateral arms (e.g., first and second lateral arms 214, 216) and/or one or more tracks (e.g., track 112 and second track 114). In some embodiments, scissor mechanism 221 may be connected (or pinned) to lead rail 212 and fixed base 219 at connecting points 222a, 222b, and arms of scissor mechanism 221 may also be connected (or pinned) to each other at connecting point 222c. In such embodiments, the arms of scissor mechanism 221 may be configured to pivot relative to one another at connecting point 222c. In some embodiments, scissor mechanism 221 may also be connected to each of lead rail 212 and fixed base at additional points having rollers 223a, 223b. In such embodiments, extendable solar assembly 200 may be configured to cause scissor mechanism 221 to move at rollers 223a, 223b, thereby causing lead rail 212 to extend and retract with respect to fixed base 219. In some embodiments, the scissor mechanism 221 may be slidably movable (i.e., similar to slides in vertical arms) with respect to a fixed base 219, such that a lead rail 212 may move (or position) between an extended position (E) and a retracted position (R). In some embodiments, extendable solar assembly 200 may include one or more multiple scissor mechanisms. In some embodiments, scissor mechanism 221 may include a threaded rod at fixed base 219 that is connected to rollers 223a, 223b. In some embodiments, scissor mechanism 221 may include an actuator 215 (not shown) connected to linkages 224a, 224b (similar to latitude arm gas springs). In some embodiments, scissor mechanism 221 may include an actuator 215 (not shown) connected between fixed base and linkages 224a, 224b. In some embodiments, scissor mechanism 221 may include a strap connected to lead rail 212 that may be pulled to retract lead rail 212 (as rollers 223a, 223b move away from connecting points 222a, 222b) and spring loaded arms that cause lead rail 212 to be extended away housing 218 (thereby pushing extendable solar assembly 200 into an extended position).

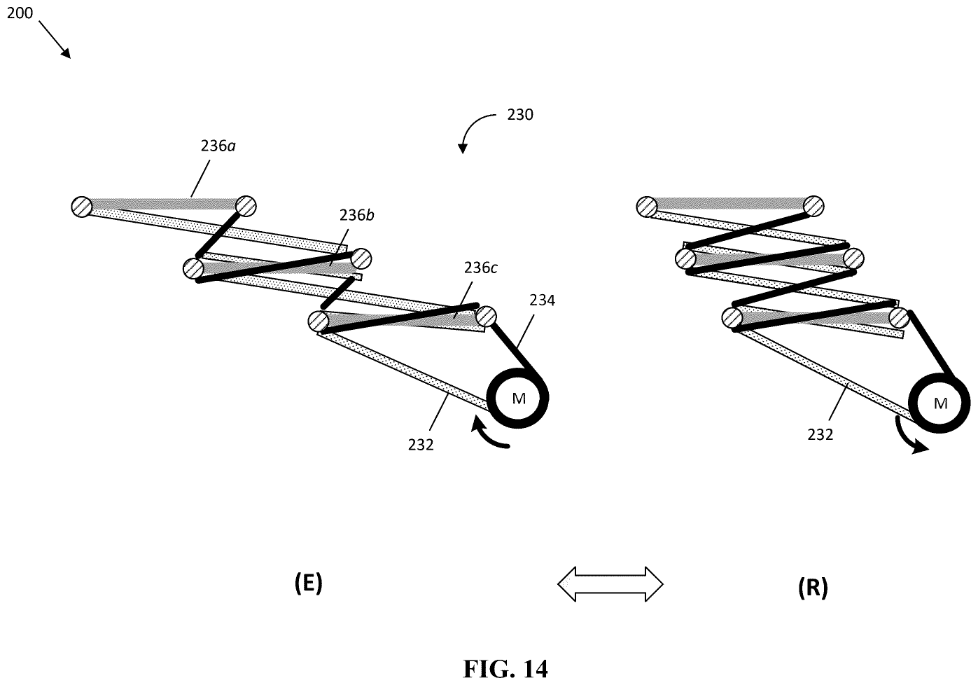

FIG. 14 depicts side cross-sectional views of extendable solar assembly 200 having a drawer slider mechanism in an extended and retracted position, according to one or more aspects described herein. In some embodiments, as depicted in FIG. 14, extendable solar assembly 200 may include a drawer slider 230 with cables 232, 234 (or links). For example, cables 232, 234 may be connected to a motor M and may be slidably movable, such that the plates 236 may move between an extended position (E) and a retracted position (R). In some embodiments, a first cable 232 may be pulled by motor M to retract extendable solar assembly 200 into a retracted position (R), and a second cable 234 may be pulled by motor M to extend the plates 236 to cause extendable solar assembly 200 to move into an extended position (E). As depicted in FIG. 14, an extendable solar assembly 200 having a drawer slider 230 may include three plates 236 (or links) for simplicity, but more drawers (or links) may be added. In some embodiments, drawer slider 230 with cables 232, 234 may be of any appropriate number of drawers, shape, size, type, and/or configuration, such that extendable solar assembly 200 may extend to an appropriate length when in a fully extended position.

FIG. 15 depicts perspective views of extendable solar assembly 200 installed on a vehicle 10, according to one or more aspects described herein. In some embodiments, extendable solar assembly 200 may include a set of solar panels 102-110, one or more slidable lateral arms (e.g., slidable lateral arms 214, 216), a housing 218, and/or one or more other components. Together, the one or more components of extendable solar assembly 200 may form an awning canopy with the set of solar panels 102-110 defining a top surface of the awning canopy. In some embodiments, extendable solar assembly 200 may also include one or more plates 236 extending between the slidable lateral arms 214, 216, each configured to support at least one solar panel of the set of solar panels 102-110. In various embodiments, the one or more slidable lateral arms are configured to support the one or more solar panels 102-110. In some embodiments, the one or more slidable lateral arms may comprise two slidable lateral arms, such as slidable lateral arms 214, 216 depicted in FIG. 15. In some such embodiments, slidable lateral arms 214, 216 may be configured to each support an outside edge of the one or more solar panels 102-110. In some embodiments, the one or more slidable lateral arms are configured to support an outside edge and/or support (or form) an inside support for the set of one or more solar panels. In various embodiments, the one or more slidable lateral arms (e.g., slidable lateral arms 214, 216) are configured to extend outwardly when extendable solar assembly 200 extends from the retracted position to the extended position and collapse such that they may be stored (or included within) a cavity formed by housing 218 when extendable solar assembly 200 retracts from an extended position to a retracted position. In various embodiments, the set of solar panels may be manually moved between an extended position and a retracted position. In other embodiments, one or more techniques described herein (e.g., with respect to FIGS. 9-14) may be used to extend or retract lead rail 212 to cause extendable solar assembly 200 to move between an extended and retracted position. For example, actuators, a motor with straps or cables, a scissor mechanism, a drawer slide mechanism, and/or one or more other techniques may be used with the embodiment depicted in FIG. 15. In some embodiments, one or more techniques described herein (e.g., with respect to FIGS. 9-14) for extending or retracting a lead rail 212 may similarly be used to extend or retract one or more solar panels of the set of solar panels (i.e., without using lead rail 212) and thus move extendable solar assembly 200 between and extended and retracted position. Indeed, in some instances of the embodiment depicted in FIG. 15, lead rail 212 may be absent or entirely decorative. Instead, the set of solar panels 102-110 may be extended and retracted using the one or more slidable lateral arms (e.g., slidable lateral arms 214, 216). Additionally, in some instances of the embodiment depicted in FIG. 15, slidable lateral arms 214, 216 may obviate the need for a track, instead serving to also guide the set of solar panels 102-110, in addition to supporting the set of solar panels 102-110 as the extendable solar assembly 200 moves between an extended and retracted position.

In various embodiments, the set of solar panels may be extendable in a cascading manner to improve performance/efficiency without requiring additional space to house or position the solar panels. In various embodiments, extendable solar assembly 200 may enable a set of solar panels 102-110 to be either stacked on top of each other (when in a retracted position) or projected outward in a side-by-side configuration to form an array (when in an extend position). In various embodiments, when in a retracted position, each solar panel of the set of solar panels may be stacked face up (i.e., with photovoltaic cells or surface configured to gather or receive sunlight facing up). In this manner, the set of solar panels may retract, from an extended position to a retracted position, into housing 218 like a deck of cards. In other embodiments, when in a retracted position, the set of solar panels may be stacked in an alternating manner such that, for example, a given solar panel is stacked face up, a next adjacent solar panel is stacked face down, the next adjacent solar panel is stacked face up, and so on. For example, in some embodiments, each solar panel of the set of solar panels may be connected via a hinge or other mechanism such that the solar panels fold at the hinge to stack on top of one another in an inverted (or alternating) manner when extendable solar assembly 200 is in a retracted position. In this manner, the set of solar panels may fold up when retracting, from an extended position to a retracted position, like a map until the set of solar panels are stacked and stowed in a retracted position (e.g., within a cavity defined by housing 218). In some embodiments when the set of solar panels are stacked in an alternating manner, a topmost solar panel (or set of solar panels) that is exposed when extendable solar assembly 200 is in a retracted position may be stacked facing upward to gather (or receive) sunlight (e.g., in a low-power mode, as described herein). In other embodiments when the set of solar panels are stacked in an alternating manner, a topmost solar panel (or set of solar panels) defining a top surface of the extendable solar assembly 200 when extendable solar assembly is in a retracted position may be stacked face down to protect the topmost solar panel (or set of solar panels) from the elements (e.g., debris, hail, and/or other potential harmful objects or aspects of the environment) when extendable solar assembly 200 is in a retracted position (and potentially not in use).

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An extendable solar assembly comprising:
a housing securely affixed to a structure during use;
a set of arms attached to the housing and configured to support a lead rail of the extendable solar assembly as the extendable solar assembly extends from a retracted position to an extended position;
at least one track coupled to the housing and the lead rail and configured to extend and retract as the extendable solar assembly extends from the retracted position to the extended position; and
a set of solar panels coupled to the at least one track, wherein the solar panels are configured to be stacked within the housing when the extendable solar assembly is in the retracted position.

2. The extendable solar assembly of claim 1, wherein the structure comprises an exterior surface of a vehicle.

3. The extendable solar assembly of claim 1, the at least one track comprising a first track and a second track, wherein the set of solar panels are coupled to the first track and the second track.

4. The extendable solar assembly of claim 1, wherein each of the set of arms, the at least one track, and the set of solar panels are retracted within the housing when the extendable solar assembly is in the retracted position.

5. The extendable solar assembly of claim 1, wherein when the set of solar panels are stacked within the housing when the extendable solar assembly is in the retracted position, at least one solar panel of the set of solar panels remains exposed, is able to gather sunlight to generate electricity, and comprises a top surface of the extendable solar assembly.

6. The extendable solar assembly of claim 1, wherein the extendable solar assembly comprises a self-contained, standalone unit configured to be removed and attached to another structure.

7. The extendable solar assembly of claim 1, wherein the set of solar panels are coupled to the at least one track via progressively taller risers.

8. The extendable solar assembly of claim 1, wherein the at least one track comprises an angled track.

9. The extendable solar assembly of claim 1, wherein the at least one track comprises a stackable track including a series of stackable links, each pivotably movable with respect to an adjacent stackable link.

10. The extendable solar assembly of claim 1, further comprising one or more actuators connected to at least the lead rail and configured to cause the extendable solar assembly to extend from the retracted position to the extended position.

11. The extendable solar assembly of claim 10, wherein the one or more actuators are retracted within the housing when the extendable solar assembly is in the retracted position.

12. The extendable solar assembly of claim 1, wherein the set of arms comprise actuated arms configured to cause the extendable solar assembly to move between the retracted position and the extended position.

13. The extendable solar assembly of claim 1, further comprising a motor configured to manipulate a strap or a cable to cause extendable solar assembly to move between the retracted position and the extended position.

14. The extendable solar assembly of claim 1, wherein a topmost solar panel of the set of solar panels when the set of solar panels are stacked within the housing comprises a curved solar panel.

15. The extendable solar assembly of claim 1, wherein each of the set of solar panels are stacked face up within the housing when the extendable solar assembly is in the retracted position.

16. The extendable solar assembly of claim 1, wherein each solar panel of the set of solar panels is stacked in an alternating manner relative to at least one adjacent solar panel of the set of solar panels within the housing when the extendable solar assembly is in the retracted position.

17. An extendable solar assembly comprising:
a housing securely affixed to a structure during use; and
a set of sliding arms configured to extend outwardly when the extendable solar assembly extends from a retracted position to an extended position and collapse when the extendable solar assembly retracts from the extended position to the retracted position; and
a set of solar panels that are coupled to the set of sliding arms, wherein the solar panels are configured to be stacked within the housing when the extendable solar assembly is in the retracted position.

18. The extendable solar assembly of claim 17, wherein the structure comprises an exterior surface of a vehicle.

19. The extendable solar assembly of claim 17, wherein the set of sliding arms include two sliding arms, each configured to support an outside edge of the set of solar panels.

20. The extendable solar assembly of claim 17, wherein the set of sliding arms are retracted within the housing when the extendable solar assembly is in the retracted position.

21. The extendable solar assembly of claim 17, wherein when the set of solar panels are stacked within the housing when the extendable solar assembly is in the retracted position, at least one solar panel of the set of solar panels remains exposed, is able to gather sunlight to generate electricity, and comprises a top surface of the extendable solar assembly.

22. The extendable solar assembly of claim 17, wherein the extendable solar assembly comprises a self-contained, standalone unit configured to be removed and attached to another structure.
